(19) United States
(12) Patent Application Publication
(10) Pub. No.: US 2005/0087727 A1
(43) Pub. Date: Apr. 28, 2005

(54) Common transfer material, liquid crystal panel, method for manufacturing liquid crystal panel

(76) Inventors: Nobuo Sasaki, Sakurai-shi (JP); Tazoh Ikeguchi, Matsusaka-shi (JP); Makoto Nakahara, Nara-shi (JP)

Correspondence Address: BIRCH STEWART KOLASCH & BIRCH, PO BOX 747, FALLS CHURCH, VA, 22040-0747, US

(21) Appl. No.: 10/504,914

(22) PCT Filed: Apr. 17, 2003
(86) PCT No.: PCT/JP03/04930

(30) Foreign Application Priority Data
May 22, 2002 (JP) 2002-147379
May 23, 2002 (JP) 2002-148860

(51) Int. Cl. H01C 1/00

(52) U.S. Cl. 252/511

(57) ABSTRACT

A common transfer material is provided that is used for a common transfer electrode provided between electrodes formed adjacently on respective inner sides of paired substrates facing each other. The common transfer material contains a resin and electrically-conductive and has a content of non-electrically-conductive filler that is at least 0 part by mass and at most 1 part by mass with respect to 100 parts by mass of the resin. A liquid-crystal panel using the common transfer material as well as a method of manufacturing the liquid-crystal panel are provided. The common transfer material with which the reliability of the liquid-crystal panel can be improved, the liquid-crystal panel using the common transfer material and the method of manufacturing the liquid-crystal panel can thus be provided.

### TECHNICAL FIELD

The present invention relates to a common transfer material used for a common transfer electrode provided between respective electrodes of two substrates, a liquid-crystal panel using the common transfer material and a method of manufacturing the liquid-crystal panel.

### BACKGROUND ART

FIG. 10 shows a cross-sectional structure of a conventional liquid-crystal panel. This conventional liquid-crystal panel 400 shown in FIG. 10 has a color filter substrate 405 and an array substrate 406 provided to face each other with a liquid-crystal layer 411 therebetween, and these substrates are attached to each other with a sealing material 412. Color filter substrate 405 and array substrate 406 have respective surfaces adjacent to liquid-crystal layer 411, and transparent electrodes 407 and 408 are formed respectively on these surfaces. Between transparent electrodes 407 and 408, a common transfer electrode 401 is provided that has a thermosetting resin 402 containing electrically-conductive particles 403 and a non-electrically-conductive inorganic filler 404. In former years, external connection terminals are provided on both of color filter substrate 405 and array substrate 406. In these years, however, external connection terminals are provided on only array substrate 406 for the purpose of simplifying interconnection for example. Accordingly, electric current flowing to transparent electrode 408 of array substrate 406 passes through conductive particles 403 in common transfer electrode 401 to flow to transparent electrode 407 of color filter substrate 405.

A method of manufacturing this conventional liquid-crystal panel is described below with reference to FIGS. 11-15. First, as shown in FIG. 11, color filter substrate 405 and array substrate 406 are provided, and then common transfer electrode 401 and sealing material 412 are provided respectively on color filter substrate 405 and array substrate 406. It is noted that color filter substrate 405 and array substrate 406 are large-sized ones and a plurality of sealing materials 412 are formed on array substrate 406. Here, as shown in FIG. 11, sealing material 412 formed on array substrate 406 is shaped, before injection of liquid crystal, to have an opening through which the liquid crystal is to be injected, instead of being shaped into a completely closed ring.

Next, color filter substrate 405 and array substrate 406 are attached to each other and then heated to harden sealing materials 412 and common transfer electrodes 401. After this, the substrates are cut at a time into respective sections each surrounded by sealing material 412 to produce a laminated substrate 415 as shown in FIGS. 12 and 13. This laminated substrate 415 is placed in a vacuum device and vacuums are generated on both of the inside and outside of the space surrounded by sealing material 412. In this state, as shown in FIG. 14, a liquid-crystal injection opening 416 is immersed in a liquid crystal 411a and the inside pressure of the vacuum device is gradually returned to atmospheric pressure. Accordingly, the pressure difference between the inside and outside of the space surrounded by sealing material 412 as well as capillary action cause liquid crystal 411a to be injected into the space. Finally, as shown in FIG. 15, after liquid crystal 411a is injected, the liquid-crystal injection opening is sealed with a sealing material 417 and a polarizer is attached on the substrate to produce liquid-crystal panel 400.

As shown in FIG. 16, however, non-conductive inorganic filler 404 is likely to be caught between conductive particles 403 and electrode 407 or electrode 408 in the stage of attaching the substrates to each other, resulting in a problem of deterioration in reliability of the liquid-crystal panel, since 10 to 30 parts by mass of non-conductive inorganic filler 404 is mixed into 100 parts by mass of thermoplastic resin 402 used for common transfer electrode 401 of this conventional liquid-crystal panel for the purpose of alleviating contraction of the resin caused by the heating in the stage of attaching the substrates to each other.

In view of the above-described circumstances, an object of the present invention is to provide a common transfer material with which the reliability of liquid-crystal panels can be improved, a liquid-crystal panel using the common transfer material and a method of manufacturing the liquid-crystal panel.

### DISCLOSURE OF THE INVENTION

With the purpose of achieving the object above, the inventors of the present invention have arrived at an idea of removing such a non-elctrically-conductive filler as inorganic filler as much as possible from the common transfer material used for the common transfer electrode and accordingly attained the present invention.

Specifically, the present invention is a common transfer material used for a common transfer electrode provided between electrodes formed adjacently on respective inner sides of paired substrates facing each other. The common transfer material contains a resin and electrically-conductive particles and has a content of non-electrically-conductive filler that is at least 0 part by mass and at most 1 part by mass with respect to 100 parts by mass of the resin.

For the common transfer material of the present invention, preferably the content of the electrically-conductive particles is 0.2 to 5 parts by mass with respect to 100 parts by mass of the resin.

For the common transfer material of the present invention, the electrically-conductive particles may have their surfaces with projections protruding outward from the electrically-conductive particles. Preferably the height of the projections is 0.05 to 5% of an average particle size of the electrically-conductive particles.

The common transfer material of the present invention may contain electrically-conductive fine particles smaller in average particle size than the electrically-conductive particles.

For the common transfer material of the present invention, the resin may be a thermosetting resin. Preferably, the thermosetting resin has a viscosity before hardening that is 10,000 to 40,000 mPa·s.

When the resin is the thermosetting resin, preferably the electrically-conductive particles have an average particle size of 105 to 125% of the distance between the electrodes formed on the substrates. Preferably, the electrically-conductive particles have a compression elasticity modulus ranging from 300 to 700 kg/mm².

When the resin is the thermosetting resin, electrically-conductive fine particles smaller in average particle size than the electrically-conductive particles may also be contained. Preferably, the content of the electrically-conductive fine particles is 10 to 30 parts by mass with respect to 100 parts by mass of the thermosetting resin.

For the common transfer material of the present invention, the resin may be a photo-curing resin. Preferably, the photo-curing resin has a viscosity before hardening that is 100,000 to 500,000 Pa·s.

When the resin is the photo-curing resin, preferably the electrically-conductive particles have an average particle size of 100 to 110% of the distance between the electrodes formed on the substrates. Still preferably, the electrically-conductive particles have a compression elasticity modulus ranging from 200 to 400 kg/mm².

When the resin is the photo-curing resin, electrically-conductive fine particles smaller in average particle size than the electrically-conductive particles may also be contained. Preferably, the content of the electrically-conductive fine particles is 0.2 to 20 parts by mass with respect to 100 parts by mass of the photo-curing resin.

Further, the present invention is a liquid-crystal panel including a first substrate, a second substrate provided so that a liquid-crystal layer is located between the first substrate and the second substrate, and a sealing material provided between the first substrate and the second substrate to surround the liquid-crystal layer. A common transfer electrode using the above-described common transfer material is provided between an electrode formed on a side of the first substrate that is adjacent to the liquid-crystal layer and an electrode formed on a side of the second substrate that is adjacent to the liquid-crystal layer.

Moreover, the present invention is a method of manufacturing a liquid-crystal panel including the steps of: providing a pair of substrates and forming a common transfer electrode using the above-described common transfer material on an upper surface of at least one of the substrates; forming a plurality of closed frames serving as a sealing material on an upper surface of at least one of the substrates; injecting a liquid crystal by applying drops of the liquid crystal into the closed frames respectively; attaching the paired substrates to each other into a laminated substrate; attaching a polarizer at a time onto the laminated substrate; and dividing at a time the laminated substrate with the polarizer attached thereto into a plurality of liquid-crystal panels.

### BRIEF DESCRIPTION OF THE DRAWINGS

FIG. 1 is a schematic enlarged cross-sectional view of an exemplary common transfer material of the present invention.

FIG. 2 is a schematic enlarged side view of an exemplary common transfer material of the present invention with projections formed on the surface of a conductive particle.

FIG. 3 is a schematic enlarged cross-sectional view showing the height of a projection formed on the surface of the conductive particle.

FIG. 4 is a schematic enlarged cross-sectional view of an exemplary common transfer material of the present invention to which conductive fine particles are added.

FIG. 5 is a schematic cross-sectional view of an exemplary liquid-crystal panel of the present invention.

FIG. 6 is a schematic conceptual view showing an exemplary step of applying liquid-crystal drops according to the present invention.

FIG. 7 is a schematic conceptual view showing an exemplary step of attaching substrates together according to the present invention.

FIG. 8 is a schematic conceptual view of an exemplary device for attaching a polarizer according to the present invention.

FIG. 9 is a schematic perspective view of an exemplary dividing device according to the present invention.

FIG. 10 shows a cross-sectional structure of a conventional liquid-crystal panel.

FIG. 11 conceptually shows a conventional substrate-laminating step.

FIG. 12 is a plan view of a conventional laminated substrate.

FIG. 13 is a perspective view of the conventional laminated substrate.

FIG. 14 conceptually shows a conventional step of injecting liquid crystal.

FIG. 15 is a plan view of a conventional liquid-crystal panel.

FIG. 16 is an enlarged cross-sectional view of a conventional common transfer electrode.

### BEST MODES FOR CARRYING OUT THE INVENTION

An embodiment of the present invention is hereinafter described.

(Common Transfer Material)

A common transfer material of the present invention includes a resin and electrically-conductive particles, and the content of a non-electrically-conductive filler is 0 to 1 part by mass, preferably 0 to 0.5 part by mass with respect to 100 parts by mass of the resin. This is because the inventors of the present invention have found that a content of more than 1 part by mass of the non-conductive filler considerably increases electrical resistance between a common transfer electrode and an electrode provided on a substrate, leading to rapid deterioration in reliability of a liquid-crystal panel.

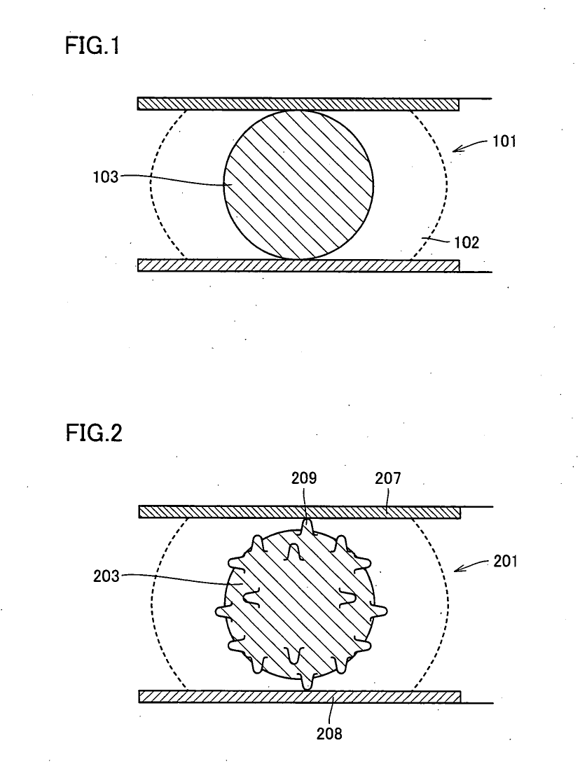

FIG. 1 shows a schematic cross-section of a preferred example of a common transfer electrode using the common transfer material of the present invention. Referring to FIG. 1, a common transfer electrode 101 has a resin 102 containing electrically-conductive particles 103 and containing no non-electrically-conductive filler like inorganic filler for example. Therefore, when the common transfer electrode as shown in FIG. 1 is used, it never occurs that such non-conductive filler as inorganic filler is caught between the electrode and the conductive particles, which is encountered by the conventional common transfer electrode, and thus the liquid-crystal panel can be improved in reliability. An example of the non-conductive filler is calcium carbonate, barium sulfate, alumina, silica, talc, magnesium oxide, zinc oxide or the like.

The resin used for the common transfer material of the present invention may be thermosetting resin or photo-curing resin for example.

(Thermosetting Resin)

The thermosetting resin that may be used for the present invention is any of those that have already been known, for example, phenol resin, urea resin, melamine resin, unsaturated polyester resin, epoxy acrylate resin, diallyl phthalate resin, epoxy resin or mixture of any of these resins. The epoxy resin that may be used is, for example, epoxy cresol novolac resin, bisphenol-A epoxy resin, bisphenol-F epoxy resin, or mixture of any of these resins.

Preferably, the viscosity of the thermosetting resin before hardening is 10,000 to 40,000 mPa·s. In this case, sufficient pressure can be applied between substrates with respective electrodes formed thereon to allow the electrodes and the conductive particles to sufficiently contact each other and thus the reliability of the liquid-crystal panel can further be improved.

(Photo-Curing Resin)

The photo-curing resin that may be used for the present invention is any of those that have already been known, for example, acrylic resin containing a polymerizable unsaturated group, alkyd resin, unsaturated polyester resin or the like. Preferably, the viscosity of the photo-curing resin before hardening is 100,000 to 500,000 Pa·s. In this case, sufficient pressure can be applied between substrates with respective electrodes formed thereon to allow the electrodes and the conductive particles to sufficiently contact each other and thus the reliability of the liquid-crystal panel can further be improved.

(Conductive Particles)

The electrically-conductive particles that may be used for the present invention is, for example, metal particles, metal-plated plastic particles or mixture of these. In particular, plastic particles plated with gold are preferably employed as the electrically-conductive particles. In this case, the conductive particles can be improved in conductivity to have a tendency to enhance the reliability of the liquid-crystal panel. Moreover, the production cost can be made lower than the production cost which is required when gold particles are used. “Conductivity” herein refers to a property of a material in the shape of a cube of 1 cm per side for example that exhibits an electrical resistance of less than 10 Ω when a voltage is applied between opposite planes of the cube. The electrical resistance of the conductive particles is more preferably at most 2 Ω.

Preferably, 0.2 to 5 parts by mass of the conductive particles are contained with respect to 100 parts by mass of the resin. When the content of the conductive particles is less than 0.2 part by mass, current cannot sufficiently be flown between the electrodes, resulting in a tendency to deteriorate the reliability of the liquid-crystal panel. When the content is more than 5 parts by mass, the number of points where the conductive particles contact each other increases. The points of contact of the conductive particles, however, sharply decrease due to thermal shock when the liquid-crystal panel is aged, resulting in a tendency to significantly increase the electrical resistance between respective electrodes formed on the substrates as compared with the electrical resistance before the aging.

When the thermosetting resin is used for the common transfer material of the present invention, preferably the conductive particles have an average particle size corresponding to 105 to 125% of the distance between electrodes formed on the substrates. In this case, sufficient contact between the conductive particles and the electrodes formed on the substrates is achieved to provide a tendency to decrease the electrical resistance between the electrodes and a tendency to enhance the reliability of the liquid-crystal panel.

When the thermosetting resin is used for the common transfer material of the present invention and the conductive particles have the average particle size corresponding to 105 to 125% of the distance between the electrodes formed on the substrates, preferably the conductive particles have a compression elasticity modulus ranging from 300 to 700 kg/mm². In this case, the superior balance between the pressure exerted by the electrodes to the conductive particles and the repulsion force exerted by the conductive particles to the electrodes can allow the electrodes and the conductive particles to sufficiently contact each other, so that the electrical resistance between the electrodes can further be reduced and the reliability of the liquid-crystal panel can further be improved.

When the photo-curing resin is used for the common transfer material of the present invention, preferably the average particle size of the conductive particles corresponds to 100 to 110% of the distance between the electrodes formed on the substrates. In this case, sufficient contact between the conductive particles and the electrodes formed on the substrates is achieved to provide a tendency to decrease the electrical resistance between the electrodes and a tendency to enhance the reliability of the liquid-crystal panel.

In the case where the photo-curing resin is used for the common transfer material of the present invention and the average particle size of the conductive particles corresponds to 100 to 110% of the distance between the electrodes formed on the substrates, preferably the conductive particles have a compression elasticity modulus ranging from 200 to 400 kg/mm². In this case, the superior balance between the pressure exerted by the electrodes to the conductive particles and the repulsion force exerted by the conductive particles to the electrodes can allow the electrodes and the conductive particles to sufficiently contact each other, so that the electrical resistance between the electrodes can further be reduced and the reliability of the liquid-crystal panel can further be improved.

In both of the case where the thermosetting resin is used for the common transfer material of the present invention and the case where the photo-curing resin is used therefor, projections protruding outward of the conductive particles may be formed on the surfaces of the conductive particles. FIG. 2 shows a schematic side view of an exemplary common transfer electrode using the common transfer material containing conductive particles having the projections formed thereon. As shown in FIG. 2, a plurality of projections 209 are formed on the surface of conductive particle 203 of common transfer electrode 201 in such a manner that projections 209 protrude outward of conductive particle 203. The structure of the conductive particles allows a plurality of projections 209 to contact electrode 207 or electrode 208 as shown in FIG. 2, so that the conductivity between electrodes 207 and 208 as well as the reliability of the liquid-crystal panel can be improved. Projections 209 described above are produced by any conventionally known method. For example, the projections may be formed by a method according to which the surface of particles for example of plastic is made uneven and the uneven surface is plated with metal for example, a method according to which the surface of such a conductive material as metal is coated with a conductive material finer than the metal material, or the like.

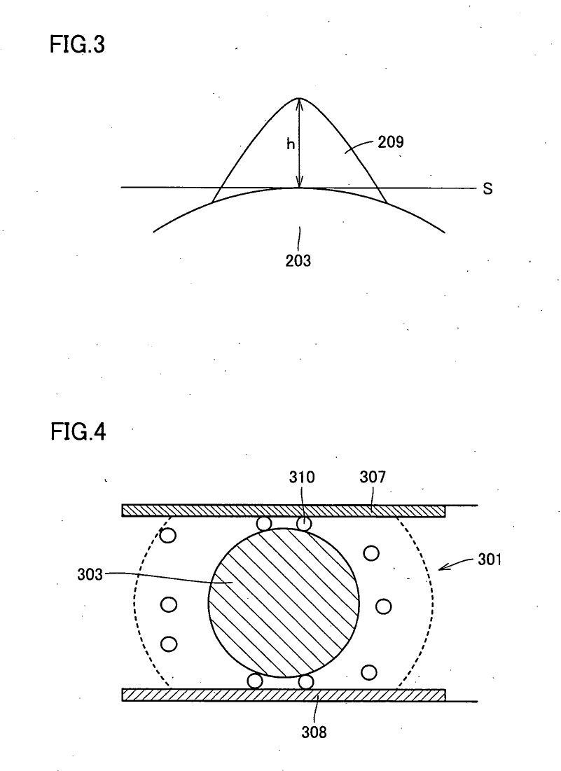

Preferably, the height of projections 209 is 0.05 to 5.0% of the average particle size of the conductive particles. When the height of the projections is smaller than 0.05% of the average particle size of the conductive particles, the projections are too short to satisfactorily obtain the effect achieved by formation of the projections and accordingly there is a tendency that the reliability of the liquid-crystal panel deteriorates. When the height of the projections is larger than 5.0% thereof, sufficient contact between the conductive particles and the electrodes formed on the substrates cannot be made so that there is a tendency that the reliability of the liquid-crystal panel deteriorates. Here, the height of projections 209 refers to the distance h as shown in FIG. 3 between the surface S contacting the surface of conductive particle 203 and the maximum height of projection 209.

Electrically-conductive fine particles having the average particle size smaller than that of the above-described conductive particles may be included in the common transfer material. FIG. 4 shows a schematic cross section of an exemplary common transfer electrode using the common transfer material of the present invention containing the conductive fine particles. As shown in FIG. 4, conductive fine particles 310 are included in a common transfer electrode 301 together with conductive particles 303. This structure allows a plurality of conductive fine particles 310 to contactan electrode 307 or 308 as shown in FIG. 4 so that the conductivity between electrodes 307 and 308 as well as the reliability of the liquid-crystal panel can be improved.

When the thermosetting resin is used for the common transfer material of the present invention, preferably the amount of the conductive fine particles to be included is 10 to 30 parts by mass with respect to 100 parts by mass of the thermosetting resin. In the case where the included amount of the conductive fine particles is less than 10 parts by mass, the amount of conductive fine particles present between the conductive particles and the electrodes formed on the substrates is insufficient, resulting in a tendency that the reliability of the liquid-crystal panel deteriorates. In the case where the included amount of the conductive fine particles is more than 30 parts by mass, the amount of the conductive fine particles is too large so that the points of contacts between conductive fine particles excessively increase, resulting in a tendency that the electrical resistance between the electrodes formed on the substrates increases.

When the photo-curing resin is used for the common transfer material of the present invention, preferably the amount of the conductive fine particles to be included is 0.2 to 20 parts by mass with respect to 100 parts by mass of the photo-curing resin. When the included amount of the conductive fine particles is less than 0.2 part by mass, the amount of conductive fine particles present between the conductive particles and the electrodes provided on the substrates is insufficient, resulting in a tendency that the reliability of the liquid-crystal panel deteriorates. When the included amount is more than 20 parts by mass, the amount of conductive fine particles are too large so that the points of contacts between the conductive fine particles excessively increase, resulting in a tendency that the electrical resistance between the electrodes formed on the substrates increases.

In both of the case where the thermosetting resin is used for the common transfer material of the present invention and the case where the photo-curing resin is used therefor, preferably the average particle size of the conductive fine particles is 0.05 to 5.0% of the average particle size of the conductive particles. When the average particle size of the conductive fine particles is less than 0.05% of that of the conductive particles, the conductive fine particles are too small resulting in a tendency that the effect obtained by the addition of the conductive fine particles cannot satisfactorily be achieved. When the average particle size of the conductive fine particles is more than 5.0% of that of the conductive particles, there is a tendency that the electrical resistance between the electrodes formed on the substrates increases.

(Other Additives)

Moreover, in the case where the thermosetting resin is used for the common transfer material of the present invention, such a conventionally known additive as hardener may be blended. As the hardener, for example, triethylenetetramine, isophoronediamine, m-xylylenediamine, polyamideamine, diaminodiphenylmethane or the like may be used. The amount of the hardener to be blended may be 0.1 to 20 parts by mass with respect to 100 parts by mass of the thermosetting resin.

In the case where the photo-curing resin is used for the common transfer material of the present invention, such a conventionally known additive as photopolymerization initiator may be blended. As the photopolymerization initiator, for example, “Darocurl 173”, “Irgacure184” or “Irgacure651” manufactured by Ciba-Geigy Corporation, “Kayacure BP” manufactured by Nippon Kayaku Co., Ltd. or the like may be used. The amount of the blended photopolymerization initiator may be 0.1 to 20 parts by mass with respect to 100 parts by mass of the photo-curing resin.

(Method of Manufacturing Common Transfer Material)

According to the present invention, the common transfer material is manufactured for example by measuring respective amounts of such a resin as thermosetting resin or photo-curing resin as described above, conductive particles, conductive fine particles, hardener or photopolymerization initiator for example so that they provide a predetermined composition, and then kneading them by a roll, mixer or the like.

(Liquid-Crystal Panel)

According to the present invention, a liquid-crystal panel includes a first substrate, a second substrate provided so that a liquid-crystal layer is located between the first substrate and the second substrate, and a sealing material provided between the first substrate and the second substrate to surround the liquid-crystal layer. A common transfer electrode using the above-described common transfer material is provided between respective electrodes formed on respective surfaces, adjacent to the liquid-crystal layer, of the first substrate and the second substrate. FIG. 5 shows a schematic cross section of an exemplary liquid-crystal panel of the present invention. Referring to FIG. 5, liquid-crystal panel 100 of the present invention includes a first substrate 105 and a second substrate 106 provided to face each other with a liquid-crystal layer 111 therebetween, an electrode 107 and an electrode 108 are formed on first substrate 105 and second substrate 106 respectively, and a sealing material 112 is formed to surround liquid-crystal layer 111. Further, a common transfer electrode 101 is provided on the inside of sealing material 112, namely inside liquid-crystal layer 111.

The liquid-crystal panel of the present invention is configured to have common transfer electrode 101 using the above-described common transfer material provided between electrodes 107 and 108, and thus the reliability of the liquid-crystal panel can remarkably be improved as compared with the conventional liquid-crystal panel using the common transfer electrode containing a large amount of non-conductive filler.

As first substrate 105 and second substrate 106, any conventionally known substrate may be used. For example, such a substrate as glass substrate or silicon substrate may be used. Moreover, on first substrate 105 and second substrate 106, such elements as color filter, black matrix and polarizer may be provided in addition to electrodes 107 and 108, sealing material 112 and common transfer electrode 101 as described above. Further, such switching elements as TFT (Thin-Film Transistor) and MIM (Metal Insulator Metal) may be provided. As electrodes 107 and 108 provided on the first and second substrates respectively, for example, such a film as ITO (Indium Tin Oxide) film or SnO₂ (tin oxide) film may be used. Common transfer electrode 101 may be provided on the outside of sealing material 112, namely outside liquid-crystal layer 111. The resin for common transfer electrode 101 and the resin for sealing material 112 may have the same composition or different compositions respectively.

Liquid-crystal layer 111 may be comprised of any conventionally known liquid crystal, for example, such a liquid crystal as TN (Twisted Nematic) liquid crystal, STN (Super Twisted Nematic) liquid crystal, TSTN (Triple Super Twisted Nematic) liquid crystal or FSTN (Film Super Twisted Nematic) liquid crystal.

The liquid-crystal panel of the present invention is suitably used for mobile phone, personal computer, word processor, television, electronic notepad, digital camera, video camera, projector, electronic calculator, clock/watch, stereo set, car navigation, microwave oven, facsimile, copying machine or the like.

(Method of Manufacturing Liquid-Crystal Panel)

According to the present invention, a method of manufacturing a liquid-crystal panel includes the steps of providing a pair of substrates and forming a common transfer electrode using the above-described common transfer material on an upper surface of at least one of the substrates, forming a plurality of closed frames serving as sealing material on an upper surface of at least one of the substrates, injecting a liquid crystal by applying drops of the liquid crystal into the closed frames respectively, attaching the substrates to each other into a laminated substrate, attaching a polarizer at a time onto the laminated substrate, and dividing at a time the laminated substrate with the polarizer attached thereto into a plurality of liquid-crystal panels.

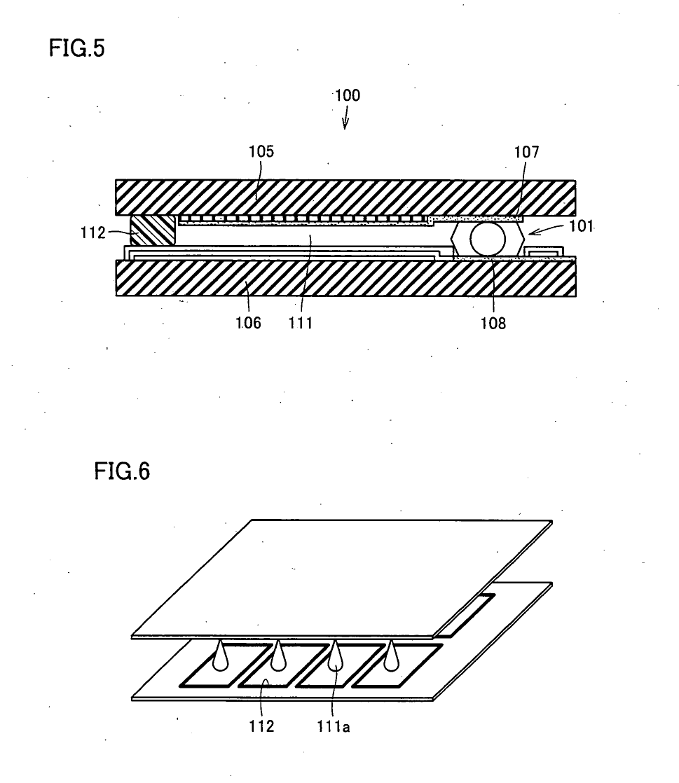

According to the method of manufacturing a liquid-crystal panel of the present invention, the liquid crystal is injected as shown in FIG. 6 for example by applying drops of liquid crystal 11a into sealing material 112 formed in the shape of the closed frame without liquid-crystal injection opening. Thus, time-consuming injection of the liquid crystal can be done at a time as shown in FIG. 6 prior to division of the laminated substrate, which means that it is unnecessary to divide the substrate into a plurality of laminated substrates and then inject the liquid crystal to each of the resultant laminated substrates. The manufacturing method of a liquid-crystal panel of the present invention can thus remarkably improve the production efficiency of liquid-crystal panels. Moreover, the manufacturing method of a liquid-crystal panel of the present invention uses the common transfer electrode comprised of the common transfer material containing almost no non-conductive filler so that the reliability of the liquid-crystal panel can further be improved. Here, the application of liquid-crystal drops is done by means of a dispenser or ink jet for example.

According to the method of manufacturing a liquid-crystal panel of the present invention, the common transfer electrode is formed or the sealing material is formed in the shape of a closed frame by applying, with a dispenser, the common transfer material or the sealing material from a small-sized syringe onto the substrate, or printing the common transfer material or the sealing material on the substrate by screen printing for example.

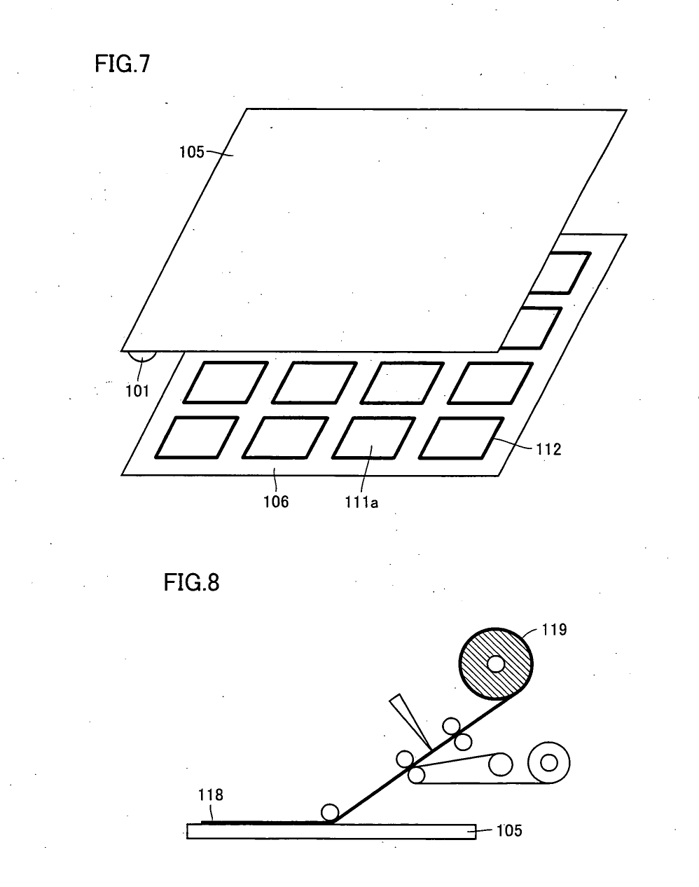

The two substrates are attached to each other, as shown in FIG. 7 for example, by laying substrate 105 with common transfer electrode 101 formed thereon over substrate 106 with sealing material 112 formed thereon in which liquid crystal 111a is injected, and pressurizing these substrates 105 and 106. After the substrates are pressurized, sealing material 112 and common transfer electrode 101 are subjected to irradiation with light of approximately 3000-5000 mJ or heating, or both of the irradiation and the heating, so that sealing material 112 and common transfer electrode 101 are hardened. Sealing material 112 and common transfer electrode 101 may be formed on different substrates respectively or on the same substrate.

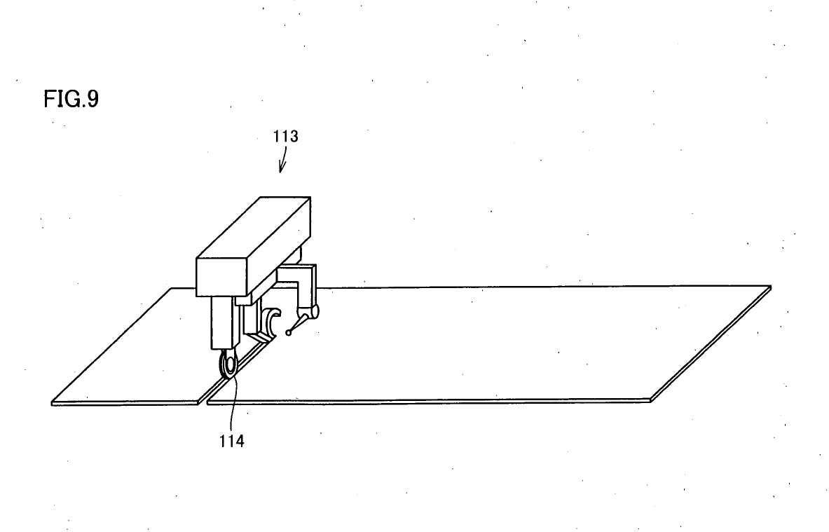

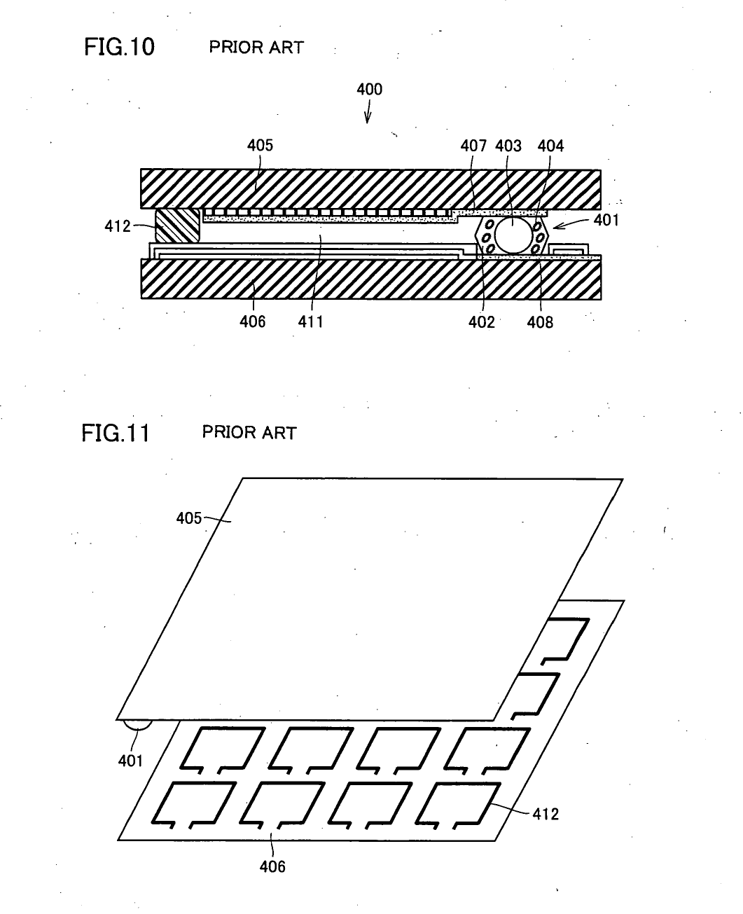

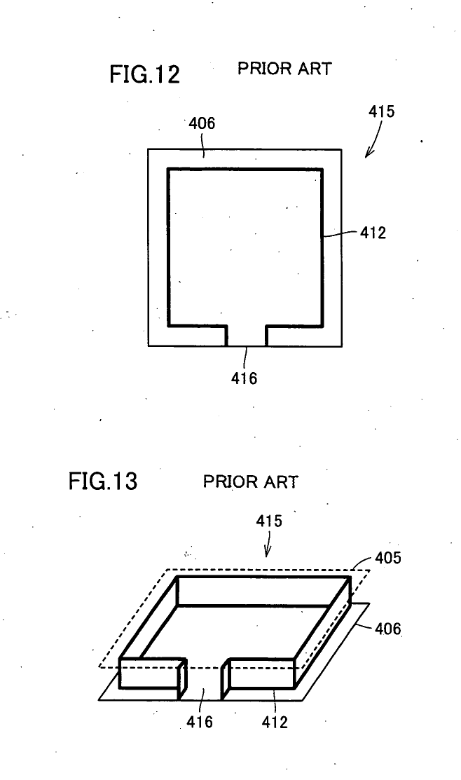

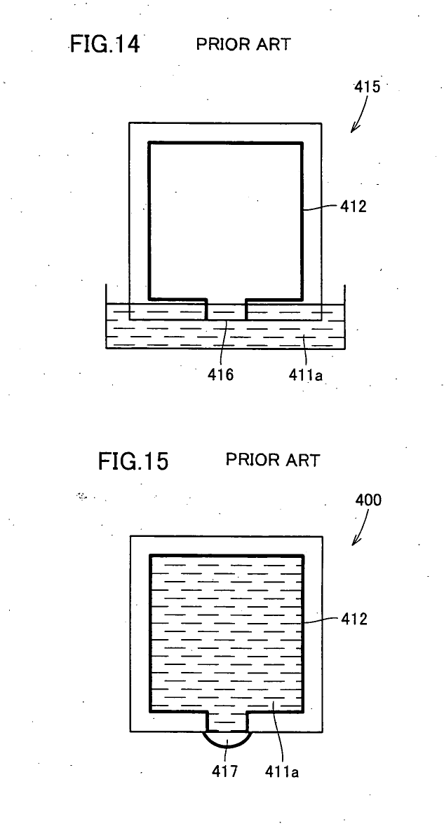

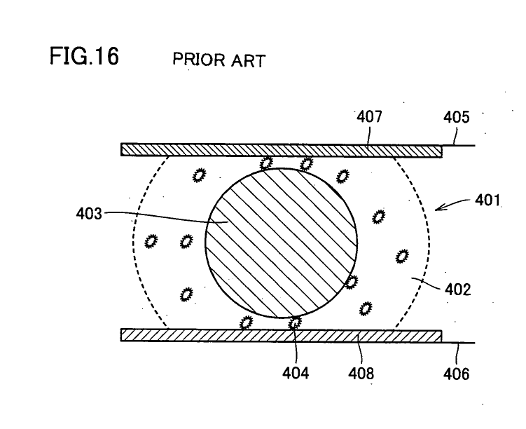

The polarizer is attached at a time onto the substrate, as shown in FIG. 8 for example, with a roll 119 around which polarizer 118 is wrapped to attach the polarizer at a time to the large-sized substrate 105. Use of this method for attaching the polarizer eliminates the need to attach the polarizer to each of cells produced by dividing the substrate, so that the production efficiency of liquid-crystal panels can remarkably be improved.

The laminated substrate is divided at a time into a plurality of liquid-crystal panels, as shown in FIG. 9 for example, with a dividing device 113 to divide the substrate at a time into liquid-crystal panels by a cutter 114.

According to the method of manufacturing a liquid-crystal panel described above, preferably a photo-curing resin is used as sealing material 112 in terms of viscosity.

### EXAMPLES

The present invention is hereinafter described in conjunction with examples. The present invention, however, is not limited to these examples.

(Preparation of Samples)

i) Preparation of Common Transfer Material

Common transfer materials respectively of examples 1-36 and comparative examples 1 and 2 were prepared by first providing components having properties shown in Tables 1-10, measuring the components according to the compositions shown in Tables 1-10, then adding, to a thermosetting resin or photo-curing resin, a hardener and/or photopolymerization initiator and mixing them with a three-roll mill, and thereafter adding electrically-conductive particles and kneading the components by vacuum centrifugal stirring method so that the average distribution amount of the conductive particles in the resin is 50±5 particles/mm².

The common transfer materials of examples 15-18 and 33-36 were prepared by a method similar to the above-described one except that, before mixture of the thermosetting resin or photo-curing resin and the hardener or photopolymerization initiator, conductive particles were added in advance to the thermosetting resin or photo-curing resin and they were mixed by tabular mixing method.

As the conductive particles of examples 1-10, 15-28 and 33-36, gold-plated plastic particles (Micropearl AU-20625 manufactured by Sekisui Chemical Co., Ltd., average particle size 6.25-6.45 μm) were used. As the conductive particles of examples 11-14 and 29-32, gold-plated plastic particles (Micropearl AULB-206 manufactured by Sekisui Chemical Co., Ltd., average particle size 6.0-6.2 μm) were used.

As for the conductive particles of examples 11-14 and 29-32 having projections, the projections were made in the following manner. Silver powder with an average particle size of 0.2 μm (manufactured by Fukuda Metal Foil & Powder Co., Ltd., trade name “Silcoat AgC-G”) was immersed in acetone which is enough to fully immerse the powder, and then dispersed with ultrasonic vibration. To this product, 3% silane-coupling (manufactured by GE Toshiba Silicones, trade name “TSC-8350”) water solution and epoxy hardener (manufactured by Shikoku Chemicals Corporation, trade name “Curezol 2MZ”) were added and dissolved, 50% epoxy resin (manufactured by Yuka-Shell Epoxy KK, trade name “Epikote-1001” was added and mixed, the plastic particles were added and mixed, and the acetone was volatilized in this state. The ratio of the mixed silver powder, silane coupling water solution and epoxy hardener was 129:4:9. The resultant product was vacuum-dried at room temperature, pulverized with a ball mill into single particles, and heated at 150° C. for 10 minutes to produce projections.

ii) Preparation of Liquid-Crystal Panel

The liquid-crystal panels of examples 1-36 and comparative examples 1 and 2 were produced in the following manner. Both of an array substrate and a color filter substrate underwent processes from cleaning to rubbing, inplane spacer (manufactured by Sekisui Chemicals Corporation, trade name “SP-2045AS”, spacer diameter 4.5 μm, fix type) was sprayed by dry spraying method onto the processed array substrate, the substrate was heated at 120° C. for 15 minutes, and thereafter the common transfer material was applied with a dispenser. The amount of applied material was in the range of 180 to 220 particles/mm² and the application was done with a target CV value of 10 or less. The application was done under conditions of nitrogen discharge pressure of 0.3 MPa and discharge time of 0.06 second, and the inner diameter of the dispenser nozzle was 0.24 mm. Under the conditions, the application was done so that the diameter of applied material was 250-300 μm and the height thereof was within 25 μm on the electrode of 900 μm×900 μm.

Then, on the color filter substrate, a sealing material of photo-curing/thermosetting epoxy resin (manufactured by Kyoritsu Chemical Co., Ltd., trade name “World Rock D70-E3”) was drawn as a sealing material with a line width of 120 μm±20 μm by means of a dispenser so that the resin forms a closed frame. Then, liquid-crystal drops were applied to inject the liquid crystal into the sealing material.

Finally, in a vacuum of 6.5×10⁻¹ Pa, the array substrate and the color filter substrate were attached together and then pressed at atmospheric pressure. The resultant pressed substrate was heated at 120° C. for 60 minutes. The substrate was cut into cells to produce liquid-crystal panels of examples 1-36 and comparative examples 1 and 2.

Regarding the discussion above, the liquid-crystal panels of examples 19-36 and comparative example 2 were produced by irradiating the array substrate and the color filter substrate pressed at atmospheric pressure with light of 4000 mJ and thereafter heating them at 120° C. for 60 minutes.

(Method of Evaluation)

The liquid-crystal panels of examples 1-36 and comparative examples 1 and 2 were evaluated by measuring the electrical resistance between electrodes of the liquid-crystal panels each to calculate the ratio of liquid-crystal panels through which electric current flows.

i) Method of Measuring Electrical Resistance

The electrical resistance between electrodes of each sample was measured using terminals around the liquid-crystal panel for connecting the liquid-crystal panel and an external signal driver. Results of the measurement are shown in Tables 1 to 10. The electrical resistance between the electrodes was measured for a liquid-crystal panel immediately after it was produced and the liquid-crystal panel aged for 500 hours at a temperature of 60° C. and a moisture content of 95%.

ii) Reliability of Liquid-Crystal Panel

The reliability of the liquid-crystal panels was evaluated using the following formula.
(reliability of liquid-crystal panel)=(number of liquid-crystal panels with current flowing therethrough)/(total number of liquid-crystal panels with its electrical resistance measured)

TABLE 1

| | | | e. 1* | e. 2 | e. 3 | e. 4 | c. e. 1** |
|---|---|---|---|---|---|---|---|
| common | composition | resin (*1) | 100 | 100 | 100 | 100 | 100 |
| transfer | | conductive particles | 0.2 | 0.2 | 0.2 | 0.2 | 0.2 |
| material | | conductive fine particles (*2) | — | — | — | — | — |
| | | inorganic filler (*3) | 1 | 1 | 1 | 1 | 17 |
| | | hardener | 10 | 10 | 10 | 10 | 10 |
| | properties | resin viscosity before | 10,000 | 40,000 | 5,000 | 45,000 | 10,000 |
| | | hardening (mPa · s) | | | | | |
| | | average particle size of | 105 | 105 | 105 | 105 | 105 |
| | | conductive particles/distance | | | | | |
| | | between electrodes (%) | | | | | |
| | | compression elasticity | 700 | 700 | 700 | 700 | 700 |
| | | modulus of conductive | | | | | |
| | | particles (Kg/mm²) | | | | | |
| | | projections absent/present | absent | absent | absent | absent | absent |
| | | height of projections/ | — | — | — | — | — |
| | | average particle size of | | | | | |
| | | conductive particles (%) | | | | | |

| | | | | | | |
|---|---|---|---|---|---|---|
| results of | electrical resistance | 50 | 60 | 50 | 70 | 120 |
| evaluation | (before aging) | | | | | |
| | electrical resistance | 70 | 70 | 70 | 90 | 140 |
| | (after aging) | | | | | |
| | reliability | 25/25 | 25/25 | 20/25 | 20/25 | 3/25 |

*e.: example
**c. e.: comparative example

TABLE 2

| | | | e. 5* | e. 6 | e. 7 |
|---|---|---|---|---|---|
| common | composition | resin (*1) | 100 | 100 | 100 |
| transfer | | conductive particles | 5 | 0.1 | 6 |
| material | | conductive fine particles (*2) | — | — | — |
| | | inorganic filler (*3) | 1 | 1 | 1 |
| | | hardener | 10 | 10 | 10 |
| | properties | resin viscosity before | 10,000 | 10,000 | 10,000 |
| | | hardening (mPa · s) | | | |
| | | average particle size of | 105 | 105 | 105 |
| | | conductive particles/distance | | | |
| | | between electrodes (%) | | | |
| | | compression elasticity | 700 | 700 | 700 |
| | | modulus of conductive | | | |
| | | particles (Kg/mm²) | | | |
| | | projections absent/present | absent | absent | absent |
| | | height of projections/average | — | — | — |
| | | particle size of conductive | | | |
| | | particles (%) | | | |

| | | | | |
|---|---|---|---|---|
| results of | electrical resistance | 60 | 50 | 60 |
| evaluation | (before aging) | | | |
| | electrical resistance | 70 | 70 | 110 |
| | (after aging) | | | |
| | reliability | 25/25 | 13/25 | 25/25 |

*e.: example

TABLE 3

| | | | e. 8* | e. 9 | e. 10 |
|---|---|---|---|---|---|
| common | composition | resin (*1) | 100 | 100 | 100 |
| transfer | | conductive particles | 0.2 | 0.2 | 0.2 |
| material | | conductive fine particles (*2) | — | — | — |
| | | inorganic filler (*3) | 1 | 1 | 1 |
| | | hardener | 10 | 10 | 10 |
| | properties | resin viscosity before | 10,000 | 10,000 | 10,000 |
| | | hardening (mPa · s) | | | |
| | | average particle size of | 125 | 105 | 125 |
| | | conductive particles/distance | | | |
| | | between electrodes (%) | | | |
| | | compression elasticity | 300 | 750 | 250 |
| | | modulus of conductive | | | |
| | | particles (Kg/mm²) | | | |
| | | projections absent/present | absent | absent | absent |
| | | height of projections/average | — | — | — |
| | | particle size of conductive | | | |
| | | particles (%) | | | |

| | | | | |
|---|---|---|---|---|
| results of | electrical resistance | 50 | 70 | 50 |
| evaluation | (before aging) | | | |
| | electrical resistance | 60 | 80 | 70 |
| | (after aging) | | | |
| | reliability | 25/25 | 25/25 | 20/24 |

*e.: example

TABLE 4

| | | | e. 11* | e. 12 | e. 13 | e. 14 |
|---|---|---|---|---|---|---|
| common | composition | resin (*1) | 100 | 100 | 100 | 100 |
| transfer | | conductive particles | 0.2 | 0.2 | 0.2 | 0.2 |
| material | | conductive fine particles (*2) | — | — | — | — |
| | | inorganic filler (*3) | 1 | 1 | 1 | 1 |
| | | hardener | 10 | 10 | 10 | 10 |
| | properties | resin viscosity before | 10,000 | 10,000 | 10,000 | 10,000 |
| | | hardening (mPa · s) | | | | |
| | | average particle size of | 105 | 105 | 105 | 105 |
| | | conductive particles/distance | | | | |
| | | between electrodes (%) | | | | |
| | | compression elasticity | 700 | 700 | 700 | 700 |
| | | modulus of conductive | | | | |
| | | particles (Kg/mm²) | | | | |
| | | projections absent/present | present | present | present | present |
| | | height of projections/average | 0.05 | 5 | 0.01 | 10 |
| | | particle size of conductive | | | | |
| | | particles (%) | | | | |

| | | | | | |
|---|---|---|---|---|---|
| results of | electrical resistance | 60 | 60 | 60 | 60 |
| evaluation | (before aging) | | | | |
| | electrical resistance | 70 | 60 | 70 | 60 |
| | (after aging) | | | | |
| | reliability | 25/25 | 12/25 | 20/25 | 10/25 |

*e.: example

TABLE 5

| | | | e. 15* | e. 16 | e. 17 | e. 18 |
|---|---|---|---|---|---|---|
| common | composition | resin (*1) | 100 | 100 | 100 | 100 |
| transfer | | conductive particles | 0.2 | 0.2 | 0.2 | 0.2 |
| material | | conductive fine particles (*2) | 10 | 30 | 5 | 40 |
| | | inorganic filler (*3) | 1 | 1 | 1 | 1 |
| | | hardener | 10 | 10 | 10 | 10 |
| | properties | resin viscosity before | 10,000 | 10,000 | 10,000 | 10,000 |
| | | hardening (mPa · s) | | | | |
| | | average particle size of | 105 | 105 | 105 | 105 |
| | | conductive particles/distance | | | | |
| | | between electrodes (%) | | | | |
| | | compression elasticity | 700 | 700 | 700 | 700 |
| | | modulus of conductive | | | | |
| | | particles (Kg/mm²) | | | | |
| | | projections absent/present | absent | absent | absent | absent |
| | | height of projections/average | — | — | — | — |
| | | particle size of conductive | | | | |
| | | particles (%) | | | | |

| | | | | | |
|---|---|---|---|---|---|
| results of | electrical resistance | 50 | 60 | 50 | 80 |
| evaluation | (before aging) | | | | |
| | electrical resistance | 70 | 100 | 70 | 100 |
| | (after aging) | | | | |
| | reliability | 25/25 | 25/25 | 22/25 | 25/25 |

*e.: example

TABLE 6

| | | | e. 19* | e. 20 | e. 21 | e. 22 | c.e. 2** |
|---|---|---|---|---|---|---|---|
| common | composition | resin (*4) | 100 | 100 | 100 | 100 | 100 |
| transfer | | conductive particles | 0.2 | 0.2 | 0.2 | 0.2 | 0.2 |
| material | | conductive fine particles | — | — | — | — | — |
| | | (*2) | | | | | |
| | | inorganic filler (*3) | 1 | 1 | 1 | 1 | 17 |
| | | photopolymerization | 1 | 1 | 1 | 1 | — |
| | | initiator (*5) | | | | | |
| | | hardener (*6) | — | — | — | — | 10 |
| | properties | resin viscosity before | 100,000 | 500,000 | 50,000 | 550,000 | 10,000 |
| | | hardening (Pa · s) | | | | | |
| | | average particle size of | 100 | 100 | 100 | 100 | 100 |
| | | conductive particles/ | | | | | |
| | | distance between | | | | | |
| | | electrodes (%) | | | | | |
| | | compression elasticity | 400 | 400 | 400 | 400 | 400 |
| | | modulus of conductive | | | | | |
| | | particles (Kg/mm²) | | | | | |
| | | projections absent/present | absent | absent | absent | absent | absent |
| | | height of projections/ | — | — | — | — | — |
| | | average particle size of | | | | | |
| | | conductive particles (%) | | | | | |

| | | | | | | |
|---|---|---|---|---|---|---|
| results of | electrical resistance | 50 | 60 | 50 | 70 | 120 |
| evaluation | (before aging) | | | | | |
| | electrical resistance | 70 | 70 | 70 | 90 | 140 |
| | (after aging) | | | | | |
| | reliability | 25/25 | 25/25 | 20/25 | 20/25 | 3/25 |

*e.: example
**c. e.: comparative example

TABLE 7

| | | | e. 23* | e. 24 | e. 25 |
|---|---|---|---|---|---|
| common | composition | resin (*4) | 100 | 100 | 100 |
| transfer | | conductive particles | 5 | 0.1 | 6 |
| material | | conductive fine particles | — | — | — |
| | | (*2) | | | |
| | | inorganic filler (*3) | 1 | 1 | 1 |
| | | photopolymerization | 1 | 1 | 1 |
| | | initiator (*5) | | | |
| | | hardener (*6) | — | — | — |
| | properties | resin viscosity before | 100,000 | 100,000 | 100,000 |
| | | hardening (Pa · s) | | | |
| | | average particle size of | 100 | 100 | 100 |
| | | conductive particles/ | | | |
| | | distance between | | | |
| | | electrodes (%) | | | |
| | | compression elasticity | 400 | 400 | 400 |
| | | modulus of conductive | | | |
| | | particles (Kg/mm²) | | | |
| | | projections absent/present | absent | absent | absent |
| | | height of projections/ | — | — | — |
| | | average particle size of | | | |
| | | conductive particles (%) | | | |

| | | | | |
|---|---|---|---|---|
| results of | electrical resistance | 60 | 50 | 60 |
| evaluation | (before aging) | | | |
| | electrical resistance | 70 | 70 | 110 |
| | (after aging) | | | |
| | reliability | 25/25 | 13/25 | 25/25 |

*e.: example

TABLE 8

| | | | e. 26* | e. 27 | e. 28 |
|---|---|---|---|---|---|
| common | composition | resin (*4) | 100 | 100 | 100 |
| transfer | | conductive particles | 0.2 | 0.2 | 0.2 |
| material | | conductive fine particles | — | — | — |
| | | (*2) | | | |
| | | inorganic filler (*3) | 1 | 1 | 1 |
| | | photopolymerization | 1 | 1 | 1 |
| | | initiator (*5) | | | |
| | | hardener (*6) | — | — | — |
| | properties | resin viscosity before | 100,000 | 100,000 | 100,000 |
| | | hardening (Pa · s) | | | |
| | | average particle size of | 110 | 100 | 100 |
| | | conductive particles/ | | | |
| | | distance between | | | |
| | | electrodes (%) | | | |
| | | compression elasticity | 200 | 500 | 100 |
| | | modulus of conductive | | | |
| | | particles (Kg/mm²) | | | |
| | | projections absent/present | absent | absent | absent |
| | | height of projections/ | — | — | — |
| | | average particle size of | | | |
| | | conductive particles (%) | | | |

| | | | | |
|---|---|---|---|---|
| results of | electrical resistance | 50 | 70 | 50 |
| evaluation | (before aging) | | | |
| | electrical resistance | 60 | 80 | 70 |
| | (after aging) | | | |
| | reliability | 25/25 | 25/25 | 20/24 |

*e.: example

TABLE 9

| | | | e. 29* | e. 30 | e. 31 | e. 32 |
|---|---|---|---|---|---|---|
| common | composition | resin (*4) | 100 | 100 | 100 | 100 |
| transfer | | conductive particles | 0.2 | 0.2 | 0.2 | 0.2 |
| material | | conductive fine particles | — | — | — | — |
| | | (*2) | | | | |
| | | inorganic filler (*3) | 1 | 1 | 1 | 1 |
| | | photopolymerization | 1 | 1 | 1 | 1 |
| | | initiator (*5) | | | | |
| | | hardener (*6) | — | — | — | — |
| | properties | resin viscosity before | 100,000 | 100,000 | 100,000 | 100,000 |
| | | hardening (Pa · s) | | | | |
| | | average particle size of | 100 | 100 | 100 | 100 |
| | | conductive particles/ | | | | |
| | | distance between | | | | |
| | | electrodes (%) | | | | |
| | | compression elasticity | 400 | 400 | 400 | 400 |
| | | modulus of conductive | | | | |
| | | particles (Kg/mm²) | | | | |
| | | projections absent/present | present | present | present | present |
| | | height of projections/ | 0.05 | 5 | 0.01 | 10 |
| | | average particle size of | | | | |
| | | conductive particles (%) | | | | |

| | | | | | |
|---|---|---|---|---|---|
| results of | electrical resistance | 60 | 60 | 60 | 60 |
| evaluation | (before aging) | | | | |
| | electrical resistance | 70 | 60 | 70 | 60 |
| | (after aging) | | | | |
| | reliability | 25/25 | 12/25 | 20/25 | 10/25 |

*e.: example

TABLE 10

| | | | e. 33* | e. 34 | e. 35 | e. 36 |
|---|---|---|---|---|---|---|
| common | composition | resin (*4) | 100 | 100 | 100 | 100 |
| transfer | | conductive particles | 0.2 | 0.2 | 0.2 | 0.2 |
| material | | conductive fine particles | 0.2 | 20 | 0.1 | 30 |
| | | (*2) | | | | |
| | | inorganic filler (*3) | 1 | 1 | 1 | 1 |
| | | photopolymerization | 1 | 1 | 1 | 1 |
| | | initiator (*5) | | | | |
| | | hardener (*6) | — | — | — | — |
| | properties | resin viscosity before | 100,000 | 100,000 | 100,000 | 100,000 |
| | | hardening (Pa · s) | | | | |
| | | average particle size of | 100 | 100 | 100 | 100 |
| | | conductive particles/ | | | | |
| | | distance between | | | | |
| | | electrodes (%) | | | | |
| | | compression elasticity | 400 | 400 | 400 | 400 |
| | | modulus of conductive | | | | |
| | | particles (Kg/mm²) | | | | |
| | | projections absent/present | absent | absent | absent | absent |
| | | height of projections/ | — | — | — | — |
| | | average particle size of | | | | |
| | | conductive particles (%) | | | | |

| | | | | | |
|---|---|---|---|---|---|
| results of | electrical resistance | 50 | 60 | 50 | 80 |
| evaluation | (before aging) | | | | |
| | electrical resistance | 70 | 100 | 70 | 100 |
| | (after aging) | | | | |
| | reliability | 25/25 | 25/25 | 22/25 | 25/25 |

*e.: example

*1: epoxy resin (“XN-21S” manufactured by Mitsui Chemicals, Inc.)
*2: tin oxide (trade name “SN-100P” manufactured by Ishihara Sangyo Kaisha, Ltd., average particle size 0.2 μm)
*3: silica (“SO-Cl” manufactured by Admafine, average particle size distribution 2 μm)
*4: acrylic modified epoxy resin A and acrylic denatured epoxy resin B at a ratio of 50: 50
*5: phenyl-2-hydroxy-2-propylketone (“Darocur 1173” manufactured by Ciba-Geigy Corporation)
*6: organic acid dihydrazide (“Amicure-VDH” manufactured by Ajinomoto Co., Inc.)

(Results of Evaluation)

As shown in Tables 1-10, the liquid-crystal panels of examples 1-36 containing only 1 part by mass of inorganic filler are considerably lower in electrical resistance than the liquid-crystal panels of comparative examples 1 and 2 containing 17 parts by mass of inorganic filler and thus remarkably superior in reliability. Further, it is seen that the liquid-crystal panels of examples 1-36 generally have the electrical resistance that remains almost the same before and after the aging process and thus are also superior in durability.

As shown in Table 1, the liquid-crystal panels of examples 1 and 2 containing the thermosetting resin with the viscosity before hardening that ranges from 10,000 to 40,000 mPa·s show a tendency to be superior in reliability to the liquid-crystal panels of examples 3 and 4 containing the thermosetting resin with the viscosity before hardening that is out of the above-described range.

As shown in Table 2, the liquid-crystal panel of example 5 containing the conductive particles with the content ranging from 0.2 to 5 parts by mass with respect to 100 parts by mass of the resin shows a tendency to be superior in reliability to the liquid-crystal panel of example 6 containing the conductive particles with the content out of the above-described range, and to be lower in electrical resistance after the aging to the liquid-crystal panel of example 7 containing the conductive particles with the content out of the above-described range.

As shown in Table 3, the liquid-crystal panel of example 8 containing the conductive particles with the average particle size ranging from 1-05 to 125% of the distance between the electrodes and having the compression elasticity modulus ranging from 300 to 700 kg/mm² shows a tendency to be lower in electrical resistance than the liquid-crystal panel of example 9 having the average particle size of the conductive particles and the compression elasticity modulus that are out of the above-described range, and to be superior in reliability to the liquid-crystal panel of example 10 having the average particle size of the conductive particles and the compression elasticity modulus that are out of the above-described range.

As shown in Table 4, the liquid-crystal panel of example 11 having the projections of the conductive particles that have the height ranging from 0.05 to 5% of the average particle size of the conductive particles shows a tendency to be superior in reliability to the liquid-crystal panel of example 13 having the height of the projections that is out of the above-described range. Further, the liquid-crystal panel of example 12 having the height of the projections in the above-described range shows a tendency to be superior in reliability to the liquid-crystal panel of example 14 with the height of projections that is out of the above-described range.

As shown in Table 5, the liquid-crystal panel of example 15 containing the conductive fine particles with the content ranging from 10 to 30 parts by mass with respect to 100 parts by mass of the thermosetting resin shows a tendency to be superior in reliability to the liquid-crystal panel of example 17 containing the conductive fine particles with the content out of the above-described range. Further, the liquid-crystal panel of example 16 containing the conductive fine particles with the content in the above-described range shows a tendency to be lower in electrical resistance before the aging process than the liquid-crystal panel of example 18 containing the conductive fine particles with the content out of the above-described range.

As shown in Table 6, the liquid-crystal panels of examples 19 and 20 containing the photo-curing resin with the viscosity before hardening that ranges from 100,000 to 500,000 Pas shows a tendency to be superior in reliability to the liquid-crystal panels of examples 21 and 22 containing the photo-curing resin with the viscosity before hardening that is out of the above-described range.

As shown in Table 7, the liquid-crystal panel of example 23 containing the conductive particles with the content ranging from 0.2 to 5 parts by mass with respect to 100 parts by mass of the photo-curing resin shows a tendency to be superior in reliability to the liquid-crystal panel of example 24 containing the conductive particles with the content out of the above-described range, and to be lower in electrical resistance after the aging process than the liquid-crystal panel of example 25 containing the conductive particles with the content out of the above-described range.

As shown in Table 8, the liquid-crystal panel of example 26 containing the conductive particles with the average particle size ranging from 100 to 110% of the distance between the electrodes and having the compression elasticity modulus ranging from 200 to 400 kg/mm² shows a tendency to be lower in electrical resistance than the liquid-crystal panel of example 27 having the average particle size of the conductive particles and the compression elasticity modulus out of the above-described ranges respectively, and be superior in reliability to the liquid-crystal panel of example 28.

As shown in Table 9, the liquid-crystal panel of example 29 having the projections of the conductive particles that have the height ranging from 0.05 to 5% of the average particle size of the conductive particles shows a tendency to be superior in reliability to the liquid-crystal panel of example 31 having the projections of the conductive particles of the height out of the above-described range. Further, the liquid-crystal panel of example 30 having the projections of the height in the above-described range shows a tendency to be superior in reliability to the liquid-crystal panel of example 32 with the projections of the height out of the above-described range.

As shown in Table 10, the liquid-crystal panel of example 33 containing the conductive fine particles with the content ranging from 0.2 to 20 parts by mass with respect to 100 parts by mass of the photo-curing resin shows a tendency to be superior in reliability to the liquid-crystal panel of example 35 containing the conductive fine particles with the content out of the above-described range. Further, the liquid-crystal panel of example 34 containing the conductive fine particles with the content in the above-described range shows a tendency to be lower in electrical resistance before the aging process than the liquid-crystal panel of example 36 containing the conductive fine particles with the content out of the above-described range.

The embodiment and examples disclosed herein are to be construed as being presented by way of illustration in every aspect, not by way of limitation. The scope of the present invention is limited only by the appended claims, not by the detailed description of the invention, and is intended to encompass all the modifications equivalent in meaning and scope to the claims.

### Industrial Applicability

According to the present invention as heretofore discussed, a common transfer material with which the reliability of a liquid-crystal panel can be improved, a liquid-crystal panel using the common transfer material and a method of manufacturing the liquid-crystal panel can be provided.

1. A common transfer material used for a common transfer electrode provided between electrodes formed adjacently on respective inner sides of paired substrates facing each other, said common transfer material containing a resin and electrically-conductive particles and having a content of non-electrically-conductive filler that is at least 0 part by mass and at most 1 part by mass with respect to 100 parts by mass of the resin.

2. The common transfer material according to claim 1, wherein
the content of said electrically-conductive particles is 0.2 to 5 parts by mass with respect to 100 parts by mass of said resin.

3. The common transfer material according to claim 1, wherein
said electrically-conductive particles have their surfaces with projections protruding outward from said electrically-conductive particles.

4. The common transfer material according to claim 3, wherein
the height of said projections is 0.05 to 5% of an average particle size of said electrically-conductive particles.

5. The common transfer material according to claim 1, containing electrically-conductive fine particles smaller in average particle size than said electrically-conductive particles.

6. The common transfer material according to claim 1, wherein
said resin is a thermosetting resin.

7. The common transfer material according to claim 6, wherein
said thermosetting resin has a viscosity before hardening that is 10,000 to 40,000 mPa·s.

8. The common transfer material according to claim 6, wherein
said electrically-conductive particles have an average particle size of 105 to 125% of the distance between the electrodes formed on said substrates.

9. The common transfer material according to claim 8, wherein
said electrically-conductive particles have a compression elasticity modulus ranging from 300 to 700 kg/mm².

10. The common transfer material according to claim 6, containing electrically-conductive fine particles smaller in average particle size than said electrically-conductive particles.

11. The common transfer material according to claim 10, wherein
the content of said electrically-conductive fine particles is 10 to 30 parts by mass with respect to 100 parts by mass of said thermosetting resin.

12. The common transfer material according to claim 1, wherein
said resin is a photo-curing resin.

13. The common transfer material according to claim 12, wherein
said photo-curing resin has a viscosity before hardening that is 100,000 to 500,000 Pa·s.

14. The common transfer material according to claim 12, wherein
said electrically-conductive particles have an average particle size of 100 to 110% of the distance between the electrodes formed on said substrates.

15. The common transfer material according to claim 14, wherein
said electrically-conductive particles have a compression elasticity modulus ranging from 200 to 400 kg/mm².

16. The common transfer material according to claim 12, containing electrically-conductive fine particles smaller in average particle size than said electrically-conductive particles.

17. The common transfer material according to claim 16, wherein
the content of said electrically-conductive fine particles is 0.2 to 20 parts by mass with respect to 100 parts by mass of said photo-curing resin.

18. A liquid-crystal panel comprising:
a first substrate;
a second substrate provided so that a liquid-crystal layer is located between said first substrate and said second substrate; and
a sealing material provided between said first substrate and said second substrate to surround said liquid-crystal layer,
a common transfer electrode using the common transfer material recited in claim 1 being provided between an electrode formed on a side of said first substrate that is adjacent to said liquid-crystal layer and an electrode formed on a side of said second substrate that is adjacent to said liquid-crystal layer.

19. A method of manufacturing a liquid-crystal panel comprising the steps of:
providing a pair of substrates and forming a common transfer electrode using the common transfer material recited in claim 1 on an upper surface of at least one of said substrates;
forming a plurality of closed frames serving as a sealing material on an upper surface of at least one of said substrates;
injecting a liquid crystal by applying drops of the liquid crystal into the closed frames respectively;
attaching said paired substrates to each other into a laminated substrate;
attaching a polarizer at a time onto the laminated substrate; and
dividing at a time the laminated substrate with said polarizer attached thereto into a plurality of liquid-crystal panels.
